(19) United States
(12) Patent Application Publication
(10) Pub. No.: US 2010/0086174 A1
(43) Pub. Date: Apr. 8, 2010

(54) METHOD OF AND APPARATUS FOR PRODUCING ROAD INFORMATION

(76) Inventors: Marcin Michal Kmiecik, Lodz (PL); Lukasz Piotr Taborowski, Lask (PL)

Correspondence Address: HARNESS, DICKEY & PIERCE, P.L.C., P.O. BOX 8910, RESTON, VA, 20195, US

(21) Appl. No.: 12/450,907

(22) PCT Filed: Apr. 18, 2008
(86) PCT No.: PCT/NL2008/050228

§ 371 Date: Nov. 12, 2009

(30) Foreign Application Priority Data
Apr. 19, 2007 (NL) PCT/NL2007/050159

(51) Int. Cl. G06K 9/00

(52) U.S. Cl. 382/103; 382/165; 382/199

(57) ABSTRACT

An embodiment of the present invention discloses a method of producing road information for use in a map database including: acquiring a source image from an image sequence obtained by means of a terrestrial based camera mounted on a moving vehicle; determining a road color sample from pixels associated with a predefined area in the source image representative of the road surface in front of or behind the moving vehicle; generating a road surface image from the source image in dependence of the road color sample; and, producing road information in dependence of the road surface image and position and orientation data associated with the source image.

### FIELD OF THE INVENTION

The present invention relates to a method for producing road information. The invention further relates to an apparatus for producing road information, a computer program product and a processor readable medium carrying said computer program product.

### PRIOR ART

There is a need to collect a large number of horizontal road information e.g. lane dividers, road centrelines, road width etc. for digital map databases used in navigation systems and the like. The geo-position of the road information could be stored as absolute or relative position information. For example, the centreline could be stored with absolute geo-position information and the road width could be stored with relative position information, which is relative with respect to the absolute geo-position of the centreline. The road information could be obtained by interpreting high resolution aerial orthorectified images. Such high resolution orthorectified images should have a pixel size below 25 cm. To obtain such images is very expensive and there is no guarantee that all the road horizontal information is captured.

Orthorectified images can be obtained very efficiently from aerial images. However, errors are often introduced, which can result in inaccurate mapping of the geo-position data. The main problem is that normally aerial images are not taken exactly perpendicular to the surface of the earth. Even when a picture is taken close to that it is only the center of the picture that is exactly perpendicular. In order to orthorectify such an image, height-of-terrain information must be additionally obtained. The lack of accurate height information of objects in an aerial image, in combination with the triangulation process used to determine the orthorectified image, can result in an inaccuracy of such images up to a dozen meters. The accuracy can be improved by taking overlapping images and comparing the same surface obtained from subsequent images from the same aerial camera. But still, there is a limit to the accuracy obtained vs. the extra cost.

Furthermore, to obtain the “horizontal” road information from aerial orthorectified images, the images have to be analysed. In the images the road surface has to be detected. Due to the position inaccuracy of the orthorectified images, the geo-position of a road in a map database can not be used to determine accurately where a road surface is located in the orthorectified image. Moreover, due to the resolution of aerial orthorectified images and strongly varying illumination of a road surface due to shadows, a road surface is hardly to detect with a colour based segmentation algorithm.

Nowadays, “vertical” road information, e.g. speed limits, directions signposts etc. for digital map databases used in navigation systems and the like, can be obtained by analysing and interpreting horizontal picture images and other data collected by a earth-bound mobile collection device. The term “vertical” indicates that an information plane of the road information is generally parallel to the gravity vector. Mobile mapping vehicles which are terrestrial based vehicles, such as a car or van, are used to collect mobile data for enhancement of digital map databases. Examples of enhancements are the location of traffic signs, route signs, traffic lights, street signs showing the name of the street etc.

The mobile mapping vehicles have a number of cameras, some of them stereographic and all of them are accurately geo-positioned as a result of the van having precision GPS and other position determination equipment onboard. While driving the road network, image sequences are being captured. These can be either video or still picture images.

The mobile mapping vehicles record more then one image in an image sequence of the object, e.g. a building or road surface, and for each image of an image sequence the geo-position is accurately determined together with the orientation data of the image sequence. Image sequences with corresponding geo-position information will be referred to as geo-coded image sequences. As the images sequences obtained by a camera represent a visual perspective view of the ‘horizontal” road information, image processing algorithms might provide a solution to extract the road information from the image sequences.

### SUMMARY OF THE INVENTION

The present invention seeks to provide an improved method of producing road information for use in a map database.

According to the present invention, the method comprises:

acquiring one or more source images from an image sequence obtained by means of a terrestrial based camera mounted on a moving vehicle;

determining a road color sample from pixels associated with a predefined area in the one or more source images representative of the road surface in front of or behind the moving vehicle including the track line of the moving vehicle;

generating a road surface image from the one or more source images in dependence of the road color sample; and,

producing road information in dependence of the road surface image and position and orientation data associated with the source image.

The invention is based on the recognition that a mobile mapping vehicle which drives on the surface of the earth, records surface collected geo-position image sequences with terrestrial based cameras. Some of said image sequences include the road in front of or behind the vehicle. Furthermore, generally, the driving direction of the vehicle is substantially similar to the direction of the road in front of or behind the vehicle. Moreover, the position and orientation of the camera with respect to the vehicle and thus with respect to the road surface is known. The position and orientation of the vehicle is determined by means of a GPS receiver and an inertial measuring device, such as one or more gyroscopes and/or accelerometers.

As the distance between the terrestrial based camera and the recorded earth surface is limited and the geo-position of the camera is accurately known by means of an onboard positioning system (e.g. a GPS receiver) and other additional position and orientation determination equipment (e.g. Inertial Navigation System INS), the absolute geo-position of each pixel assumed that the pixel is a representation of the earth surface can accurately be determined Furthermore, the orientation data of the camera with respect to the vehicle enables us to determine for each image an area or group of pixels in an image that represents with a degree of certainty the road surface. This enables us to obtain automatically and accurately a color spectrum sample of the road surface. The color spectrum sample comprises all values of colors of the pixels that correspond to the assumed road surface. The color spectrum is used to detect in the image the pixels that could correspond to the road surface. The thus obtained road surface image is used to detect the borders of the road, which enables us to derive road information such as the absolute or relative position of the centerline and the road width. Preferably, the predefined area to obtain the road color sample corresponds to the road surface between the lane markings of the lane the vehicle is driving on. In this way, generally the road color sample corresponds to the color spectrum of the background color of the road surface or the pavement material. Now, only the pixels corresponding to the road color background will be selected as road surface and the pixels corresponding to lane markings will be excluded. In this way, from the road surface image the road edges and road centerline as well as lane information, such as lane dividers, lane widths, lane markings, lane paintings, etc. can be detected and located.

In an embodiment of the invention, producing road information comprises:

determining road edge pixels in the road surface image;

performing curve fitting on the road edge pixels to obtain a curve representing a road edge and

calculating the road information in dependence of the position of the curve in the road surface image and the corresponding position and orientation data.

In a further embodiment of the invention the road surface image has been selected from an area of the one or more source images representing a predefined area in front of or behind the moving vehicle including the track line of the moving vehicle. Each pixel in an “vertical” image obtained by a camera has a corresponding resolution in the horizontal plane. The resolution decreases with the distance between the vehicle and the road surface. These features enable us to derive the position information with a guaranteed accuracy by not taking into account the pixels representing the earth surface farther than a predetermined distance in front of or behind the vehicle.

In a further embodiment of the invention, acquiring a source image comprises:

processing one or more images from the image sequence in dependence of position data and orientation data associated with said one or more images to obtain the one or more source images wherein each source image corresponds to an orthorectified image. This feature has the advantage that the perspective view of a road surface is converted in a top view image of the road surface. In the orthorectified image the borders and centerline of a road are parallel to each other. Furthermore, each pixel of an orthorectified image represents a similar size of the earth surface. These properties enables to derive efficiently and accurately the road information from the orthorectified image. The use of more than one image enables us to generate an orthorectified image, i.e. orthorectified mosaic for a road segment and to derive the road information for said road segment from said orthorectified image.

In an embodiment of the invention, producing road information comprises:

determining road edge pixels in the road surface image;

performing a line fitting algorithm to obtain lines representative of the road edges; and,

calculating the road information in dependence of the lines, and the position and orientation data. These features allows the program to determine efficiently the road edges and corresponding road information for use in a map database.

In an embodiment of the invention, producing road information comprises:

determining road edge pixels in the road surface image;

determining the position of a strip in the road surface image comprising a maximum related to the number of road edge pixels belonging to the stripe, wherein the strip has a predefined width and a direction parallel to the driving direction of the moving vehicle associated with the road surface image;

performing a line fitting algorithm on the road edge pixels belonging to the strip to obtain lines representative of the road edges; and,

calculating the road information in dependence of the lines, and the position and orientation data. In this embodiment is first determined the most probable position parallel to the driving direction of the road side in the image and subsequently only the road edge pixels near to said position are taken into account to derive the road information. The colors of the road surface pixels do not have one color but have a collection of different colors. Therefore, in the road surface image the border of the road surface is not a straight line but rather a very noisy or wavy curve. The strip corresponds to a quadrilateral in a source image representing a perspective view and is a rectangle in a source image representing an orthorectified view. The features of this embodiment reduce the possibility that disturbances in the images decreases the accuracy of the position information associated with the road information. If the source image is an orthorectified image, wherein a column of pixels corresponds to a line parallel to the driving direction, the features of this embodiment can be very efficiently implemented and processed by:

determining road edge pixels in the road surface image;

counting for each column the number of road edge pixels to obtain an edge pixel histogram;

filtering the edge pixel histogram to obtain the position of columns representative of the road edges;

calculating the road information in dependence of the position of the column, and the position and orientation data.

These features enables us to determine very easily and efficiently the position of the road surface border. By means of the associated orientation and position data, an orthorectified image could be obtained wherein a column corresponds to the driving direction. In this way, the strip is oriented parallel to the driving direction and corresponds to one or more adjacent columns. In this way the number of edge pixels in the strip can be easily counted by counting first for each column the number of edge pixels and subsequently for each column position the number of edge pixels in the one or more adjacent columns.

In an advantageous embodiment filtering comprises:

determining the position of a column in the histogram having a maximum related to the number of counted road edge pixels in one or more adjacent columns. And in a further embodiment calculating comprises

determining the position of a left border of the road surface by computing the mean value of the column position of the edge pixels in the one or more columns adjacent to the determined position of a column in the histogram having a maximum at a left part of the road surface image;

determining the position of a right border of the road surface by computing the mean value of the column position of the edge pixels in the one or more columns adjacent to the determined position of a column in the histogram having a maximum at a right part of the road surface image;

calculating the road information in dependence of the position of the left side and right side. These features provide a simple and fast algorithms to produce the road information. And in a further embodiment of the invention, the road information comprises a set of parameters representing the position of the centre of a road, wherein calculating comprises determining the set of parameters by calculating the average position of the positions of the left and right border of the road surface. And in another further embodiment of the invention, the road information comprises a road width parameter, wherein calculating comprises deriving a value of the road width parameter by means of calculating the distance between the position of the left and right border of the road surface. In this way, the road information corresponding to the centre and width of the road can be easily obtained.

In an embodiment of the invention, the road information has been produced by processing a first and a second image from the image sequence, wherein the first image in time follows the second image. This feature enables us to detect pixels corresponding to moving objects.

In a further embodiment of the invention, the method further comprises:

determining a common area within two consecutive source images representing a similar geographical area of the road surface;

determining for pixels of the common area whether it has to be classified as a stationary pixel or a moving object pixel. These features enables us to determine for pixels of consecutive images having similar geo-position when projected on a common plane which represents the earth surface before or behind the moving vehicle, whether the pixels visualize in both images the same object or different objects.

In a further embodiment, the road color sample has been determined from the stationary pixels in the predefined area and moving object pixels are excluded. This feature enables us to obtain a better estimation of the color spectrum of the road surface.

In a further embodiment of the invention, the road colors sample is determined from a predefined area of the common area. This feature enables the engineer practicing the invention to restrict the pixels used to determine the road color sample to pixels which should normally, with a very high degree of certainty, be a representation of the road surface.

In a further embodiment of the invention, the road surface image is generated from the common area. These features enable us to check in two orthorectified images whether a pixel represents the road surface.

In an advantageous embodiment of the invention, generating a road surface image comprises:

detecting pixels of moving objects in the common area; and

marking said pixels to be excluded from the road surface.

By means of said features objects moving on the road surface in front of or behind the car can be excluded from the road surface. The common area of the first and the second image are recorded at different times. An object moving across the road surface will have different positions in the first and second image. Movements can be detected with well known image processing algorithms and subsequently the position of the moving object in the first and second image can be determined. This enables us to obtain an image that indicates which pixels of the orthorectified image are assumed to correspond to road surface pixels.

In another embodiment of the invention producing road information comprises:

processing the pixels of the road surface image not having an indication to represent a road surface pixel to detect, identify and extract road information describing lane markings and other painted road markings. If the road color sample is obtained from pixels representing only the background color of the road surface, the pixels corresponding to road paintings will not be assigned as road surface pixel. The road painting will be seen as holes in the road surface image. Road information such as lane dividers, halt lines, solid lane lines, dashed lines and other normalized road markings can be identified by analyzing the holes and their corresponding position and orientation.

The present invention can be implemented using software, hardware, or a combination of software and hardware. When all or portions of the present invention are implemented in software, that software can reside on a processor readable storage medium. Examples of appropriate processor readable storage medium include a floppy disk, hard disk, CD ROM, DVD, memory IC, etc. When the system includes hardware, the hardware may include an output device (e.g. a monitor, speaker or printer), an input device (e.g. a keyboard, pointing device and/or a microphone), and a processor in communication with the output device and processor readable storage medium in communication with the processor. The processor readable storage medium stores code capable of programming the processor to perform the actions to implement the present invention. The process of the present invention can also be implemented on a server that can be accessed over telephone lines or other network or internet connection.

### SHORT DESCRIPTION OF DRAWINGS

The present invention will be discussed in more detail below, using a number of exemplary embodiments, with reference to the attached drawings that are intended to illustrate the invention but not to limit its scope which is defined by the annexed claims and its equivalent embodiment, in which

FIG. 1 shows a MMS system with a camera;

FIG. 2 shows a diagram of location and orientation parameters;

FIG. 3 is a block diagram of an exemplar implementation of the process for producing road information according to the invention;

FIG. 4 shows a side view of the general principle of conversion of source images into orthorectified tiles;

FIG. 5 shows a top view of the general principle of conversion of source images into orthorectified tiles;

FIG. 6 shows the conversion of a stereoscopic image pair into two orthorectified tiles;

FIG. 7 shows the result of superposing the two orthorectified tiles in FIG. 6;

FIG. 8 shows an area for obtaining a road color sample;

FIG. 9 shows the result of superposing two subsequent images;

FIG. 10 shows the result of detection of pixels associated with moving objects;

FIG. 11 shows an orthorectified image with road surface, road edge and computed road edges;

FIG. 12 shows an example of a bar chart of counted edge pixels in a column of an orthorectified image for determining the position of a road edge;

FIG. 13 visualizes the determination of the center line;

FIG. 14 shows a block diagram of a computer arrangement with which the invention can be performed.

FIGS. 15a, 15b and 15c show an example of three source images taken from an image sequence;

FIG. 16 shows an orthorectified mosaic of the road surface obtained from the images sequence corresponding to the source images shown in FIG. 15,

FIG. 17 shows the road surface image overlying the orthorectified mosaic shown in FIG. 16; and

FIG. 18 illustrates the invention when applied on one image.

### DETAILED DESCRIPTION OF EXEMPLARY EMBODIMENTS

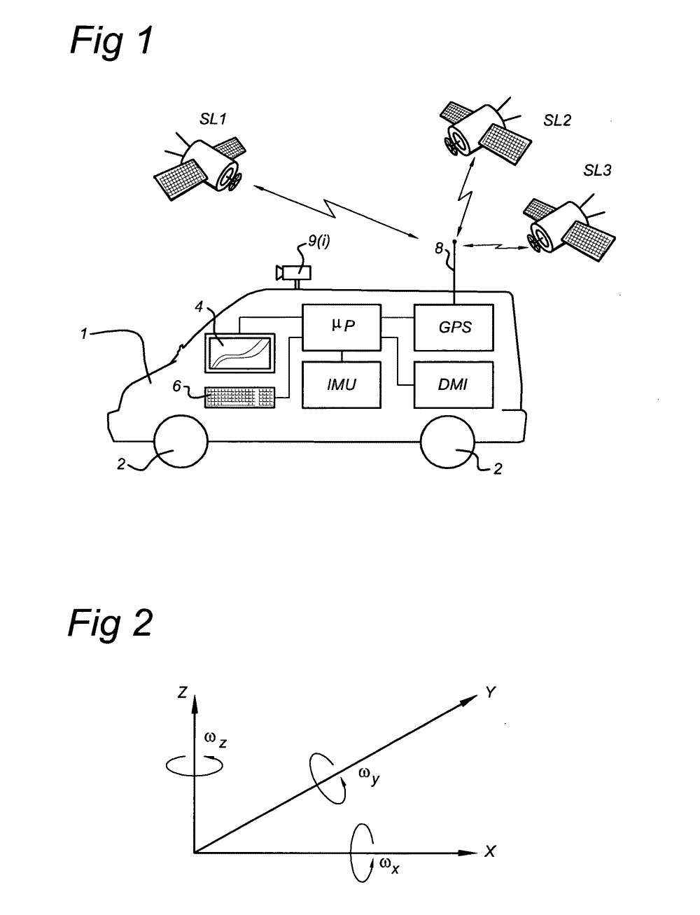

FIG. 1 shows a MMS system that takes the form of a car 1. The car 1 is provided with one or more cameras 9(i), i=1, 2, 3, . . . I. The car 1 can be driven by a driver along roads of interest.

The car 1 is provided with a plurality of wheels 2. Moreover, the car 1 is provided with a high accuracy position determination device. As shown in FIG. 1, the position determination device comprises the following components: a GPS (global positioning system) unit connected to an antenna 8 and arranged to communicate with a plurality of satellites SLi (i=1, 2, 3, . . . ) and to calculate a position signal from signals received from the satellites SLi. The GPS unit is connected to a microprocessor μP. Based on the signals received from the GPS unit, the microprocessor μP may determine suitable display signals to be displayed on a monitor 4 in the car 1, informing the driver where the car is located and possibly in what direction it is traveling. Instead of a GPS unit a differential GPS unit could be used. Differential Global Positioning System (DGPS) is an enhancement to Global Positioning System (GPS) that uses a network of fixed ground based reference stations to broadcast the difference between the positions indicated by the satellite systems and the known fixed positions. These stations broadcast the difference between the measured satellite pseudoranges and actual (internally computed) pseudoranges, and receiver stations may correct their pseudoranges by the same amount.

a DMI (Distance Measurement Instrument). This instrument is an odometer that measures a distance traveled by the car 1 by sensing the number of rotations of one or more of the wheels 2. The DMI is also connected to the microprocessor μP to allow the microprocessor μP to take the distance as measured by the DMI into account while calculating the display signal from the output signal from the GPS unit.

an IMU (Inertial Measurement Unit). Such an IMU can be implemented as 3 gyro units arranged to measure rotational accelerations and translational accelerations along 3 orthogonal directions. The IMU is also connected to the microprocessor μP to allow the microprocessor μP to take the measurements by the DMI into account while calculating the display signal from the output signal from the GPS unit. The IMU could also comprise dead reckoning sensors.

The system as shown in FIG. 1 is a so-called “mobile mapping system” which collect geographic data, for instance by taking pictures with one or more camera(s) 9(i) mounted on the car 1. The camera(s) are connected to the microprocessor μP. The camera(s) 9(i) in front of the car could be a stereoscopic camera. The camera(s) could be arranged to generate an image sequence wherein the images have been captured with a predefined frame rate. In an exemplary embodiment one or more of the camera(s) are still picture cameras arranged to capture a picture every predefined displacement of the car 1 or every interval of time. The predefined displacement is chosen such that two subsequent pictures comprise a similar part of the road surface, i.e. having the same geo-position or representing the same geographical area. For example, a picture could be captured after each 8 meters of travel.

It is a general desire to provide as accurate as possible location and orientation measurement from the 3 measurement units: GPS, IMU and DMI. These location and orientation data are measured while the camera(s) 9(i) take pictures. The pictures are stored for later use in a suitable memory of the μP in association with corresponding location and orientation data of the car 1, collected at the same time these pictures were taken. The pictures include information as to road information, such as center of road, road surface edges and road width.

FIG. 2 shows which position signals can be obtained from the three measurement units GPS, DMI and IMU shown in FIG. 1. FIG. 2 shows that the microprocessor μP is arranged to calculate 6 different parameters, i.e., 3 distance parameters x, y, z relative to an origin in a predetermined coordinate system and 3 angle parameters ωₓ, ω_{y}, and ω_{z}, respectively, which denote a rotation about the x-axis, y-axis and z-axis respectively. The z-direction coincides with the direction of the gravity vector.

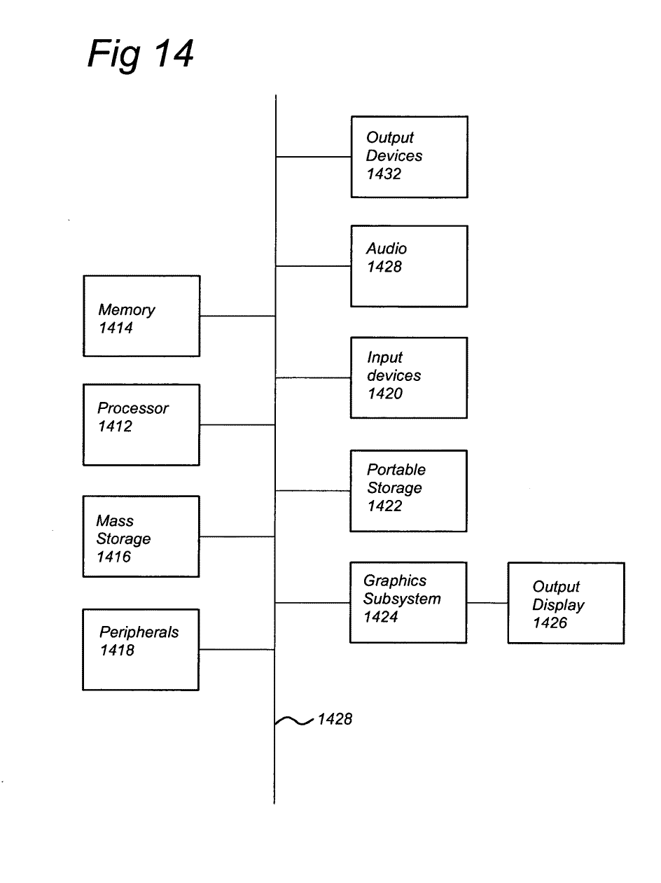

The microprocessor in the car 1 and memory 9 may be implemented as a computer arrangement. An example of such a computer arrangement is shown in FIG. 14.

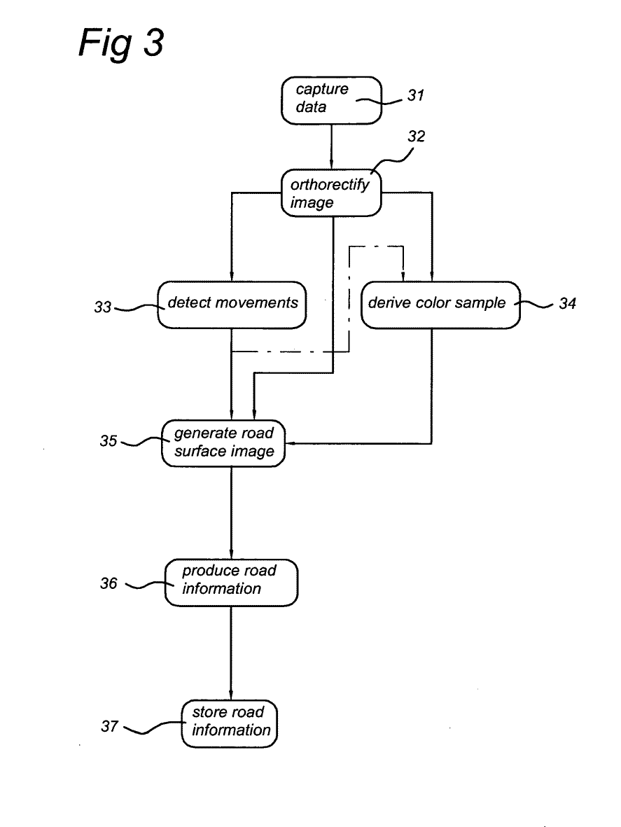

FIG. 3 shows a block diagram of an exemplary embodiment of the process of producing road information according to the invention. The process starts with an MMS (Mobile Mapping System) Session 31, by capturing sequences of source images with associated position and orientation data by means of a mobile mapping vehicle as shown in FIG. 1 and storing the captured data on a storage medium. In process block 32 the captured data is processed to generated an orthorectified tile for each source image with associated position and orientation data. The associated position and orientation data includes the position signals that can be obtained from the GPS, DMI and IMU and the position and orientation of the respective cameras relative to the position and orientation of the car. The generation of an orthorectified tile from a source image will be described below in more detail. The position and orientation data enables us to superpose two consecutive images, comprising similar part of the road surface representing the same geographical area having the same geo-position. Furthermore, from position and orientation data in the captured data, the track line of the car can be determined.

The orthorectified tiles are used to detect pixels corresponding to moving objects on the road surface and to derive a road color sample. Block 33 represents the process of detecting pixels of moving objects and block 34 represents the process for deriving the road color sample. Both processes are performed simultaneously on the same image. Therefore, block 33 generates for an n^{th} image an orthorectified binary n^{th} image wherein for each pixel is indicated whether or not the pixel corresponds to a stationary or a moving object and block 34 generates for the n^{th} image an associated road color sample. A road color sample is a collection of color values with values that have been recognized to be colors of the road surface in one or more consecutive source images, for example the values of pixels of the n^{th} image that based on the orientation of the camera with respect to the driving direction of the mobile mapping vehicle should under normal conditions represent road surface. For example, the road color sample is taken from the pixels from a polygon in the image, wherein the area of the polygon corresponds to the road surface the vehicle will drive on.

In block 35 the road color sample of the n^{th} source image is used to select all the pixels in the n^{th} source image having a color included in the road color sample. Subsequently, the pixels of the n^{th} image that have been identified to correspond to a moving object will be marked to be non stationary pixels. The result of block 35 is a binary orthorectified image indicating for each pixel whether or not the associated pixel in the n^{th} image corresponds to the road surface and corresponds to a moving object.

In block 36, the left and right side or the road positions are determined from the binary orthorectified image. The algorithm to determine the left and right side of the road will be described below in more detail. The determined positions are used to derive the position of center of the road surface and the width of the road surface shown in the n^{th} image. By means of the position and orientation data associated with the n^{th} source image the corresponding geo-position of the center of the road can be calculated.

Furthermore, in block 36 the binary orthorectified image is used to detect, identify and extract road information describing lane markings and other painted road markings. If the road color sample is obtained from pixels representing only the background color of the road surface, the pixels corresponding to road paintings will not be assigned as road surface pixel. The road paintings will be seen as holes in the binary image. Road information such as lane dividers, halt lines, solid lane lines, dashed lines and other normalized road markings can be identified by analyzing the holes and their corresponding position and orientation. The shape and size of a hole is determined and matched with known characteristics of lane markings and other normalized road paintings. In an embodiment, a polygon is generated for each hole. The polygon is used to identify the corresponding road painting. By identifying the lane dividers of a road in an image, the total number of lanes can be derived. The position and orientation of a hole that matches could be verified with respect to the road side, centerline of the road and position of neighboring road markings, to decrease the number of wrongly detected road information items. Furthermore, the color values of the pixels within a hole can be used to analyze the hole to further decrease erroneous detections.

In block 37, the calculated center of the road and road width and other road information items are stored as attributes in a database for use in a digital map database. Such a digital map database could be used in a navigation application, such as a navigation system and the like, to show on a display a perspective view or top view a representation of the road a user is driving on or to use the information in connection with directions giving or safety applications. The respective blocks shown in FIG. 3 will now be disclosed in more detail.

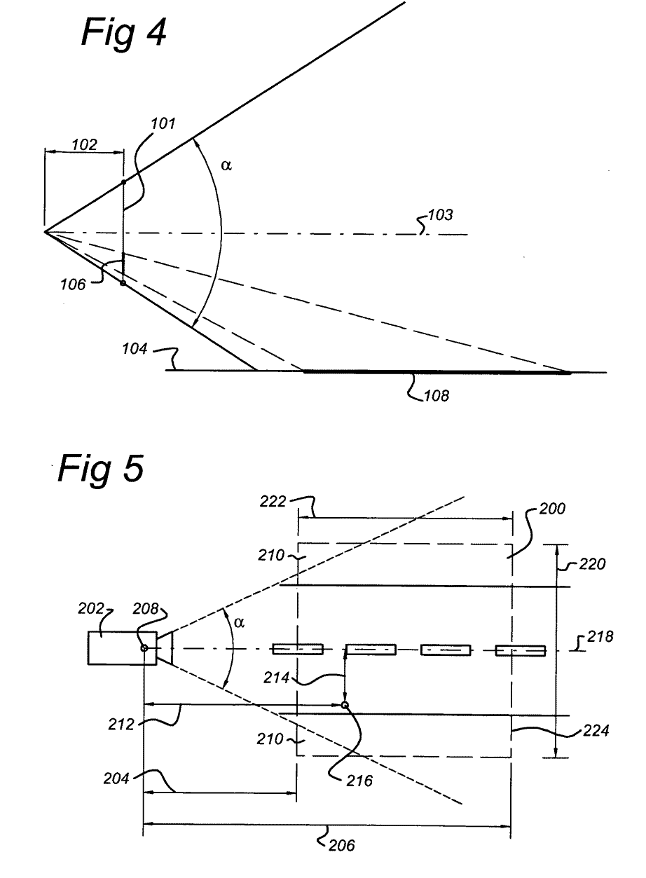

FIG. 4 shows a side view of the general principle of conversion of a source image into orthorectified tiles which is performed in block 32. An image sensor 101 in a camera or CCD-camera 202 (shown in FIG. 2) records a sequence of source images. The source images represent more or less vertical images which are recorded by a terrestrial based camera 9(i) mounted on a car as shown in FIG. 1. The source images could be a sequence of still pictures recorded by means of a still picture camera, which camera is triggered every displacement of e.g. 8 meters. A camera comprising the image sensor has an angle of view, a. The angle of view a is determined by the focal length 102 of the lenses of the camera. The angle of view a could be in the range of 45°<α<180°. Furthermore, the camera has a looking axis 103, which is in the centre of the angle of view. In FIG. 1, the looking axis 103 is parallel to a horizontal plane 104. The image sensor 101 is mounted perpendicular to the looking axis 103. In this case, the image sensor 101 records “pure” vertical source images. If further the height of the image sensor is known with respect to a horizontal plane, e.g. the earth surface, the image recorded by the image sensor 101 can be transformed to an orthorectified tile representing a scaled version of the top view of the horizontal plane. To obtain a horizon image with a suitable resolution in the horizontal direction, a limited area of the image sensor is used. FIG. 4 shows the part 106 of the image sensor 101 that corresponds to the part 108 in the horizontal plane. The minimal acceptable resolution of the orthorectified tile determines the maximum distance between the image sensor and the farthest point in the horizontal plane. By means of trigonometry the source image retrieved from the terrestrial based camera can be converted to any virtual plane. Even if the looking axis is angled with a known angle with respect to the horizontal plane, an orthorectified tile can be obtained from a source image.

FIG. 5 shows a top view of the general principle of conversion of a source images into an orthorectified tile 200. The viewing angle α and the orientation of the looking axis 103, 218 of the camera 202 determine the part of the horizontal plane that is recorded by the image sensor 101. The border of the orthorectified tile 200 is indicated by reference 224. In FIG. 5, the looking axis 218 of the camera 202 coincide with the direction centre axis with lane markings of the road. Collection of the attributes and accuracy necessary for navigation systems and the like require a predefined minimum resolution of the orthorectified tiles. These requirements restrict the part of the horizontal plane that could be obtained from the source images. The maximum distance 206 between the position of the camera focal point 208 with respect to the horizontal plane and the boundary of the area of the horizontal plane determines the minimum resolution. Furthermore, practically, the maximum distance 206 could be restricted by the minimum distance between two cars when driving on a particular road. By limiting the maximum distance thusly, it has the advantage that in most cases the road surface in the orthorectified tile does not comprise the back of a car driving in front of the mobile mapping vehicle. Furthermore, the difference between maximum distance 206 and minimum distance 204 determines the maximum allowable distance between subsequent recordings of images by a camera. This could restrict the maximum driving speed of the vehicle. A rectangle of the horizontal plane corresponds to an area approximately having the form of a trapezoid in the source image. From FIG. 5 can be seen that the minimum distance and the angle of view a determine whether the orthorectified tile 200 comprises small area's 210 which do not have corresponding area's in the source image. The orthorectified tile 200 is the dashed square and the small area's 210 are the small triangles cutting off the close in corners of the dashed square indicated by 200.

In an embodiment the orthorectified tile 200 corresponds to an area of 16 m width 220 and 16 m length 222. In the event the images are captured each 8 meter, 99% of road surface could be seen in two consecutive images. For further processing of the orthorectified tiles it is advantageous to have orthorectified tiles in the form of a rectangle. The pixels of the orthorectified tile which do not have an associated pixel in the source image will be given a predefined color value. An example of a predefined color value is a color corresponding to a non-existing road surface color or a value which will generally not be present or almost not present in source images. This reduces the possibility of errors in the further processing of the orthorectified tiles.

In an embodiment of the conversion of the source image to obtain the orthorectified tile for each pixel 216, having a distance 214 from the looking axis and a distance 204 from the focal point 208, the corresponding position in the source image is determined by means of trigonometry which is described in more detail in unpublished patent application PCT/NL2006/050252, which is incorporated herewith by reference. It should be noted that resolution (physical size that each pixel represents) is changed (made larger) when converting the source image to the orthorectified image. The increase in size is done by averaging the color values of the associated pixels in the source image to obtain the color value of the pixel of the orthorectified image. The averaging has the effect of clustering the road surface color sample and reducing noise within the process.

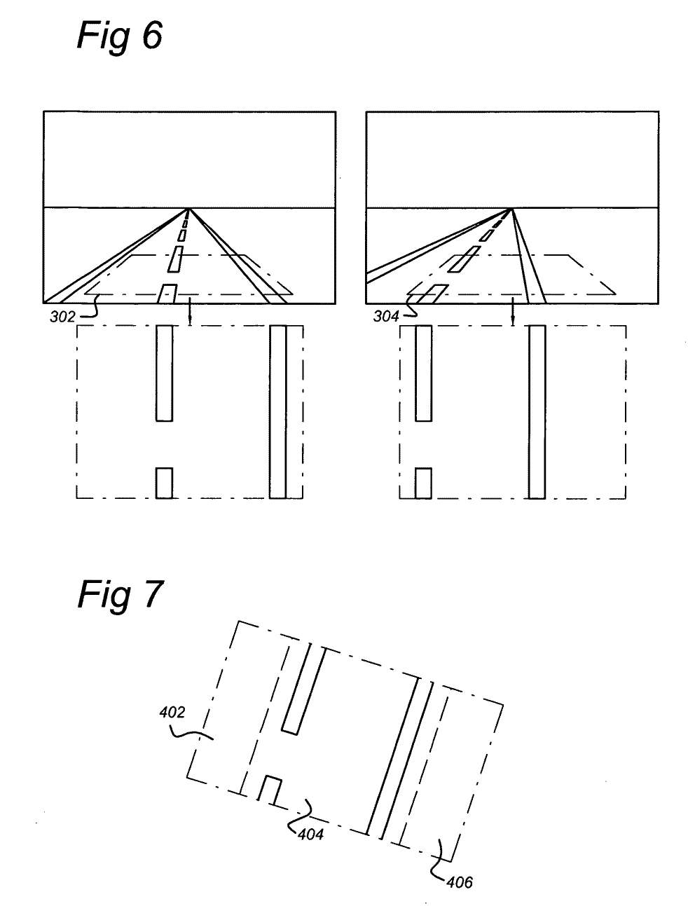

In one embodiment, FIG. 6 shows at the upper side a stereoscopic pair of images. At the lower side two corresponding converted orthorectified tiles are shown. The value of a pixel in the orthorectified tiles could be derived by first determining by means of trigonometry or triangulation of the corresponding position in the source image and secondly copying the value of the nearest pixel in the source image. The value could also be obtained by interpolation between the four or 9 nearest pixels. The dashed lines 302 and 304 indicate the area of the source images used to obtain the orthorectified tiles. In a preferred embodiment the orthorectified tile is a rectangle. The use of a stereoscopic camera will result in two orthorectified tile sequences with a relatively large overlapping area. FIG. 7 shows the orthorectified mosaic obtained by superposing the two orthorectified tiles in FIG. 6. The superposition could be based on the geo-positions of the respective orthorectified tiles. The geo-position of each orthorectified tile is derived from a position determination function including the GPS-position from the moving vehicle, the driving direction or orientation of the moving vehicle, the position of the camera on the moving vehicle and the orientation of the camera on the moving vehicle. The parameters to derive the geo-position of an orthorectified tile are stored as position and orientation data associated with a source image. The left area 402 and the right area 406 of the orthorectified mosaic are obtained from the left and right orthorectified tile in FIG. 6, respectively. The middle area 404 of the orthorectified mosaic is obtained from the corresponding area of the left or the right orthorectified tile. An advantage of using a stereoscopic camera or two cameras in front is that a bigger/broader orthorectified mosaic could be obtained, as two camera can record images over a larger angle then only one of said cameras. Similarly, using a front looking camera in combination with side looking cameras enables us to obtain an accurate orthorectified mosaic from very broad roads, or streets with pavements. In this way orthorectified images representing a road surface in its full width can be generated.

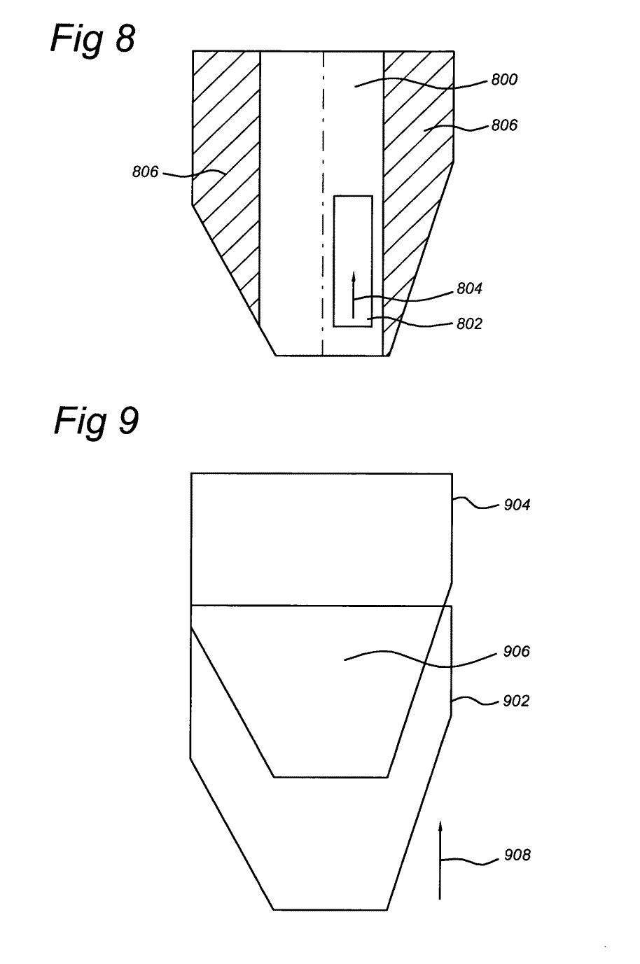

In block 34 a road color sample is obtained from an orthorectified image to detect the road surface in the orthorectified image. FIG. 8 shows an example of an area for obtaining a road color sample. A car drives on a road 800. Arrow 804 identifies the driving direction of the car. The areas indicated with 806 are the roadside. As the car drives on a road, we can assume that every thing directly before the car has to be road. However the pixels of the road surface do not have one color but colors from a so-called color space. In each orthorectified image a predefined area 802 which normally comprised pixels representing the road surface, is defined. The predefined area 802 could be in the form of a rectangle which represents the pixels in an area from 5-11 meters in the lane in front of the mobile mapping vehicle. Preferably, the predefined area includes the track line of the vehicle and is sufficiently narrow as to exclude pixels containing colors from lane markings and to include only pixels representative of the background color of the road surface. The colors from the pixels in the predefined area 802 are used to generate a road color sample. The road color sample is used to determine whether a pixel is probably road surface or not. If a pixel has a color value present in the road color sample of the orthorectified image, the pixel is probably road surface. The road color sample could best be obtained from images recording the road in front of the mobile mapping vehicle, e.g. one of the images of an image pair from a stereoscopic camera, as these images includes the track line of the vehicle and the track line is normally over road surface. A road color sample could be taken from one image to detect the road surface in said image. An engineer can find many ways to obtain a color sample and may average over many parameters. The road color sample could in another embodiment be taken from more than one consecutive images. The road color sample could also be determined every n^{th} image and be used for the n^{th} image and the (n−1) consecutive images. It is important to obtain regularly a road color sample as the color of the road surface depends heavily on the lighting conditions of the road and the light intensity. A road surface in the shadow will have a significant different road color sample as a road surface in direct sunlight. Therefore, if enough processing power is available for each orthorectified image a corresponding road color sample should be determined and used to detect the road surface in said image. Furthermore, the road color samples from several images may be combined to enable filtering of unwanted transitory samples.

The road color sample could be contaminated by colors of a moving object in front of the moving vehicle. Therefore, optionally, the color values of the pixels detected in block 33 as moving object pixels could be excluded from the road color sample. In this way, contamination of the road color sample could be avoided. This option is indicated in FIG. 3 by the dashed line to block 34.

It should be noted that FIG. 8 represents an orthorectified part of a source image. The outline of the part is not symmetrical (as shown) when the looking axis is not parallel to the driving direction of the vehicle.

To be able to determine the width and center of a road, the camera(s) have to capture the full width of a road. Normally, when a car is driving on the road there is a minimum distance between the vehicle in front of the car. This distance can be used to determine the predefined area to obtain the road color sample. Furthermore, it can be assumed that nothing else other than road surface could be seen in the image up to the car in front of the car. However, in the other lanes of the road, moving objects such as cars, motorcycles, vans, can pass the mobile mapping vehicle. The pixels corresponding to the moving vehicles should not be classified to be road surface.

Block 33 in FIG. 3, detects pixels of moving objects in the source images. The pixels of moving objects can be detected in the common area of two consecutive orthorectified images. FIG. 9 shows the result of superposing two subsequent images. Reference numbers 902 and 904 indicate the boundary of the parts of the n^{th} and (n+1)^{th} orthorectified image having pixels that have been derived from the n^{th} and (n+1)^{th} source image. Arrow 908 indicates the driving direction of the mobile mapping vehicle. Assume the n^{th} and (n+1)^{th} orthorectified image comprises 16 meter of road in the driving direction and the (n+1)^{th} image is taken after 8 meter displacement of the mobile mapping vehicle after capturing the n^{th} image. In that case, there is a common plane 906 of 8 meter in the driving direction of the vehicle. The pixels corresponding to the common plane 906 of the n^{th} image corresponds to another time instant then the pixels corresponding to the common plane of the (n+1)^{th} image. A moving object will have different positions in the n^{th} and (n+1)^{th} image, whereas stationary objects will not move in the common plane 906. Pixels of moving objects can be found by determining the color distance between pixels having an equivalent position in the common plane 906.

A pixel of the n^{th} image in the common plane 906 is represented by rₙ, gₙ, bₙ, wherein r, g and b correspond to the red, green and blue color value of a pixel. A pixel of the (n+1)^{th} image at the same position in the common plane 906 is represented by rₙ₊₁, gₙ₊₁, bₙ₊₁. In an exemplar embodiment, the color distance of said pixels having the same position in the common plane is determined by the following equation:

$$dist = \frac{distR + distG + distB}{3}$$

$$wherein \text{:}$$

$$distR = {( {r}_{N} - {r}_{N + 1} )}^{2}$$

$$distG = {( {g}_{N} - {g}_{N + 1} )}^{2}$$

$$distB = {( {b}_{N} - {b}_{N + 1} )}^{2}$$

If dist>thr², wherein thr is an adaptive threshold value, then the pixel represents a moving object otherwise the pixel represents something stationary. In an embodiment the threshold is a distance of 10²-15² in classical RGB space. Another approach is to use a distance relative to a spectrum characteristic, for example average color of pixels. An engineer can find many other ways to determine whether a pixel represents a moving object or something stationary.

It should be noted that instead of RGB space any other color space could be used in the present invention. Example of color spaces are the absolute color space, LUV color space, CIELAB, CIEXYZ, Adobe RGB and sRGB. Each of the respective color spaces has it particular advantages and disadvantages.

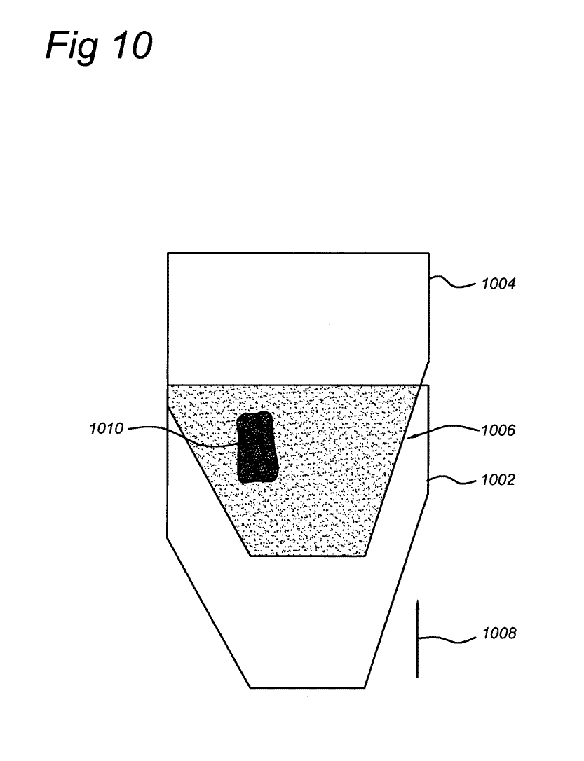

FIG. 10 shows the exemplary result after performing the detection of pixels corresponding to moving objects on the pixels of the common plane 1006 of the n^{th} and (n+1)^{th} orthorectified image 1002, 1004. The result is a binary image wherein white pixels are associated with stationary objects and black pixels are associated with moving objects. A moving object is an object that has a different geo-position in the n^{th} and (n+1)^{th} source image. The movement is detected in the common plane 1006 of the n^{th} and (n+1)^{th} orthorectified image 1002, 1004 and a pixel in the common plane is associated with a moving object if said pixel has a color shift which is more than the threshold amount between two successive images. The moving object 1010 in FIG. 10 could be a vehicle driving on another lane. Arrow 1008 indicates the driving direction of the vehicle carrying the camera.

The road color sample associated with the n^{th} image generated by block 34 is used to detect the pixels representing the road surface in the n^{th} image and to generate a road surface image. For each pixel of the common plane 906 of the n^{th} image, a check is made whether the color value of the pixel is in the road color sample or within a predetermined distance from any color of the road color sample or one or more characteristics from the road color sample, for example the average color or the color spectrum of the road color sample. If it is, the corresponding pixel in the road surface image will be classified to be a road surface pixel. It should be noted that a pixel in an orthorectified image is obtained by processing the values of more than one pixel of a source image. This reduces the noise in the colors spectrum of the road color sample and consequently improves the quality of the road surface pixel selection and identification. Furthermore, it should be noted that texture analysis and segment growing or region growing algorithms could be used to select the road surface pixels from the orthorectified image. The binary image associated with the n^{th} image generated by block 33 indicating whether a pixel is a stationary pixel or corresponds to a moving object is used to assign to each pixel in the road surface image a corresponding parameter. This two properties of the road surface image are used to select road edge pixels and to generate a road edge image. First, for each row of the road surface image the most left and right pixels are selected, identified and stored as part of road edge pixels for further processing. It should be noted that other algorithms could be used to select the road edge pixels, for example selecting the pixels of the road surface forming the most left and right chain of adjacent pixels. Secondly, for each road edge pixel, it is verified whether its location is near pixels corresponding to a moving object. If a road edge pixel is near a moving object pixel, said pixels could be marked as questionable or could be excluded from the road edge pixels in the binary image. A road edge pixel is regarded to be near to a moving object pixel if the distance between the road edge pixel and nearest moving object pixel is less then three pixels. In an embodiment, a road edge pixel is marked questionable or excluded when the corresponding pixel in the road surface is marked as a moving object pixel. The questionable indication could be used to determine whether it is still possible to derive automatically with a predetermined reliability the position of a road edge corresponding to the source image. If too many questionable road edge pixels are present, the method could be arranged to provide the source image to enable a human to indicate in the source image or orthorectified source image the position of the left and/or right road edge. The thus obtained positions are stored in a database for further processing. Thus, a pixel of the common plane is classified to be a road edge pixel if the binary image generated by block 33, indicates that said pixel is a stationary pixel and the color of the associated pixel in the orthorectified image is a color from the road color sample. Any pixel not meeting this requirement is classified not to be a road edge pixel. When the road surface image is visualized and pixels corresponding to moving objects are excluded from the road surface pixels, a moving object will be seen as a hole in the road surface or a cutout at the side of the road surface.

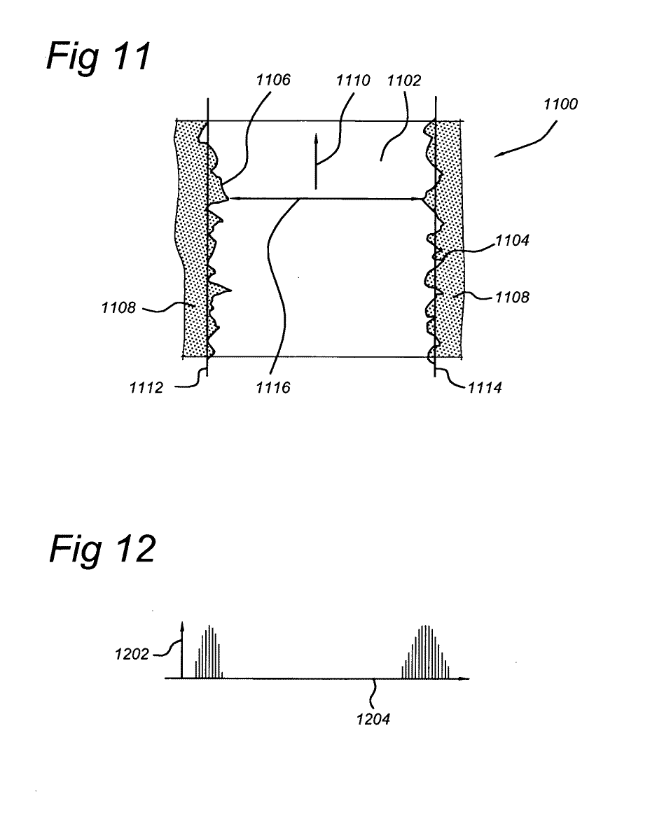

FIG. 11 shows an idealized example of a road surface image 1100, comprising a road surface 1102, left and right road edges 1104, 1106 and the grass border along the road 1108. Furthermore, FIG. 11 shows as an overlay over the road surface image 1100, the driving direction of the vehicle 1110 and the computed left and right side 1112, 1114 of the road. The edges 1104, 1106 of the road surface 1102 are not smooth as the color of the road surface near the road side can differ from the road color sample. For example, the side of road could be covered with dust. Furthermore, the road color can deviate too much due to shadows. Therefore, the edges are jagged. In block 36 firstly the edge pixels in the road surface image will be determined. Edge pixels are the extreme road surface pixels on a line 1116 perpendicular to the driving direction. In this way holes in the interior of the road surface due to moving objects or other noise will not result in a false detection of a road edge. It should be noted that in FIG. 11 the road edges 1104 and 1106 are represented by continuous lines. In practice, due to for example moving objects, the road edges could be discontinuous, as road edge pixels which are marked questionable could be excluded.

Secondly, the edge points are fitted to a straight line. The algorithm described below is based on the assumption that the edge of a road is substantially parallel to the driving direction of the vehicle. A strip or window parallel to the driving direction is used to obtain a rough estimation of the position of the left and right side of the road surface in the road surface image. The strip has a predefined width. The strip is moved from the left side to the right side and for each possible position of the strip the number of road edge pixels falling within the strip is determined. The number of road edge pixels for each position can be represented in a bar chart. FIG. 12 shows a bar chart that could be obtained when the method described above is applied to a road surface image like FIG. 11 for determining the position of a roadside. The vertical axis 1202 indicates the number of road edge pixels falling within the strip and the horizontal axis 1204 indicates the position of the strip. The position forming a top or having locally a maximum number of pixels, is regarded to indicate roughly the position of the roadside.

The position is rough as the precise position of the roadside is within the strip. The position of the roadside can be determined by fitting the edge pixels falling in the strip to a straight line parallel to the driving direction. For example, the well known linear least square fitting technique could be used to find the best fitting straight line parallel to the driving direction through the edge pixels. Also polygon skeleton algorithms and robust linear regression algorithms, such as median based linear regression, have been found very suitable to determine, the position of the road edges, road width and centerline. As the geo-position of the orthorectified image is known, the geo-position of the thus found straight line can be calculated very easily. In a similar way the position of the right roadside can be determined. It should be noted that the edge pixels could be applied to any line fitting algorithm so as to obtain a curved roadside instead of a straight road edge. This would increase the processing power needed to process the source images, but could be useful in bends of a road. The determined road edges and centerline are stored as a set of parameters including at least one of the positions of the end points and shape points. The set of parameters could comprise parameters for representing the coefficients of a polynomial which represents the corresponding line.

The algorithm for determining the position of the roadside defined above can be used on any orthorectified image wherein the driving direction of the vehicle is known with respect to the orientation of the image. The driving direction and orientation allows us to determine accurately the area within the images that corresponds to the track line of the vehicle when the vehicle drives on a straight road or even bent road. This area is used to obtain the road color sample. As the track line is normally across the road surface, the road color sample can be obtained automatically, without performing special image analysis algorithms to determine which area of an image could represent road surface.

In an advantageous embodiment, block 32 is arranged to generate orthorectified images wherein the columns of pixels of the orthorectified image correspond with the driving direction of the vehicle. In this case the position of a roadside can be determined very easily. The number of edge pixels in a strip as disclosed above, corresponds to the sum of the edge pixels in x adjacent columns, wherein x is the number of columns and corresponds to the width of the strip. Preferably, the position of the strip corresponds to the position of the middle column of the columns forming the strip. In an embodiment the width of the strip corresponds to a width of 1.5 meters

An algorithm to determine the position of a roadside could comprises the following actions:
for each column of pixels count the number of edge pixels;
for each column position summarize the number of edge pixels of x adjacent columns;
determine position of column having local maximum in number of summarized edge pixels of the x adjacent columns;
determine the mean (column) position of the edge pixels corresponding to the x adjacent columns associated with the previously determined position.

All these actions can be performed with simple operation, such as counting, addition, comparing and averaging. The local maximum in the left part of an orthorectified image is associated with the left roadside and the local maximum in the right part of an orthorectified image is associated with the right roadside.

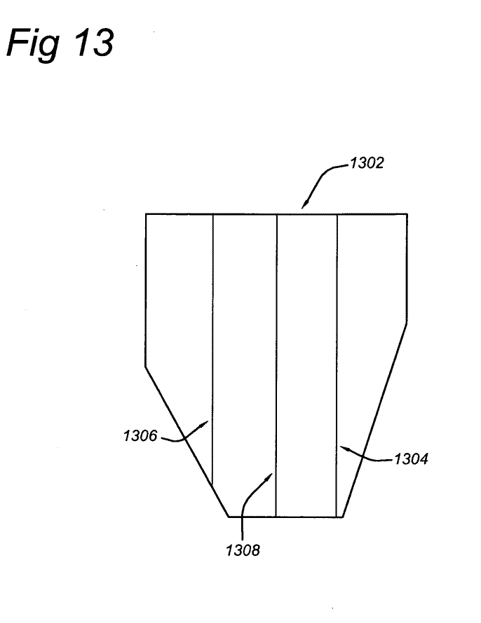

After having determined the positions of straight lines corresponding to the left and right roadside, the center of the road can be determined by calculating the average position of the left and right roadside. The center of the road can be stored as a set of parameters characterized by for example the coordinates of the end points with latitude and longitude. The width of the road can be determined by calculating the distance between the position of the left and right roadside. FIG. 13 shows an example of an orthorectified image 1302. Superposed over the image are the right detected edge of the road, the left detected edge of the road and the computed centre line of the road.

It should be noted that the method described above uses both the color information and the detection of pixels associated with moving objects. It should be noted that the method also performs well without the detection of said pixels. In that case, each time only one source image is used to produce road information for use in a map database.

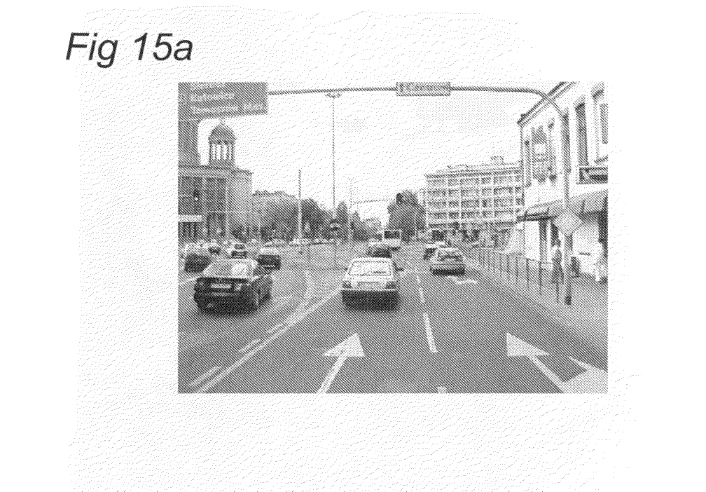

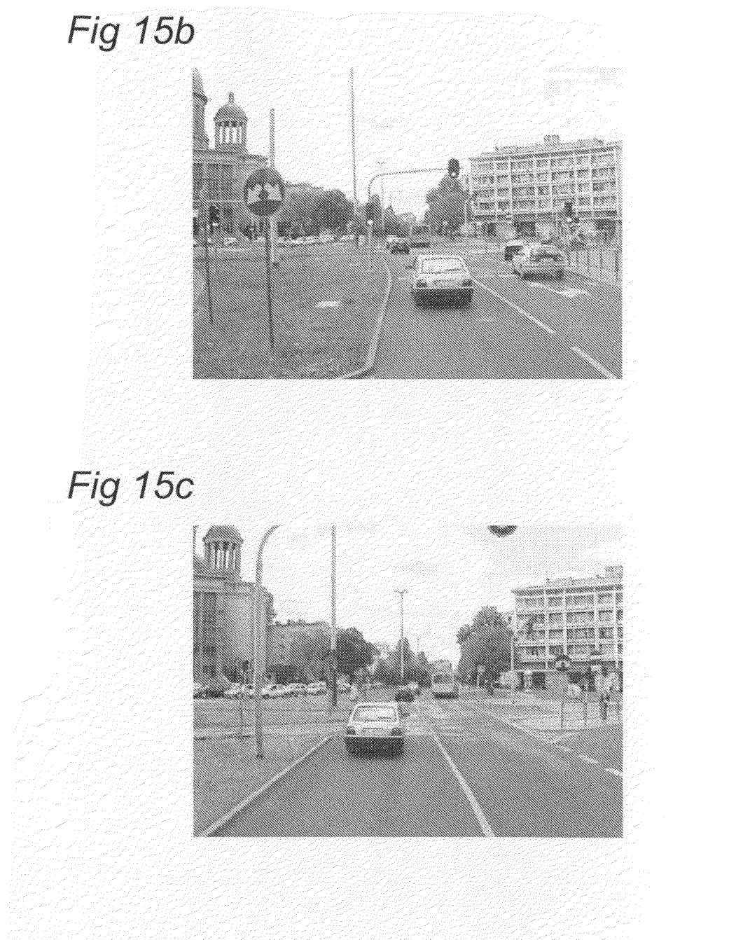

FIGS. 15a, 15b and 15c show an example of three source images taken from an image sequence obtained by a MMS system as shown in FIG. 1. The image sequence has been obtained by taking at regular intervals an image. In this way a image sequence with predefined frame rate, for example 30 frames/second or 25 frames/second is generated. The three source images shown in FIGS. 15a-c are not subsequent images of the image sequence. By means of the high accuracy positioning device for each image the camera position and orientation can be determined accurately. By means of the method described in unpublished patent application PCT/NL2006/050252, the perspective view images are converted into orthorectified images, wherein for each pixel the corresponding geo-position can be derived from the position and orientation data. The position and orientation data associated with each orthorectified image enables to generate an orthorectified mosaic from the orthorectified images.

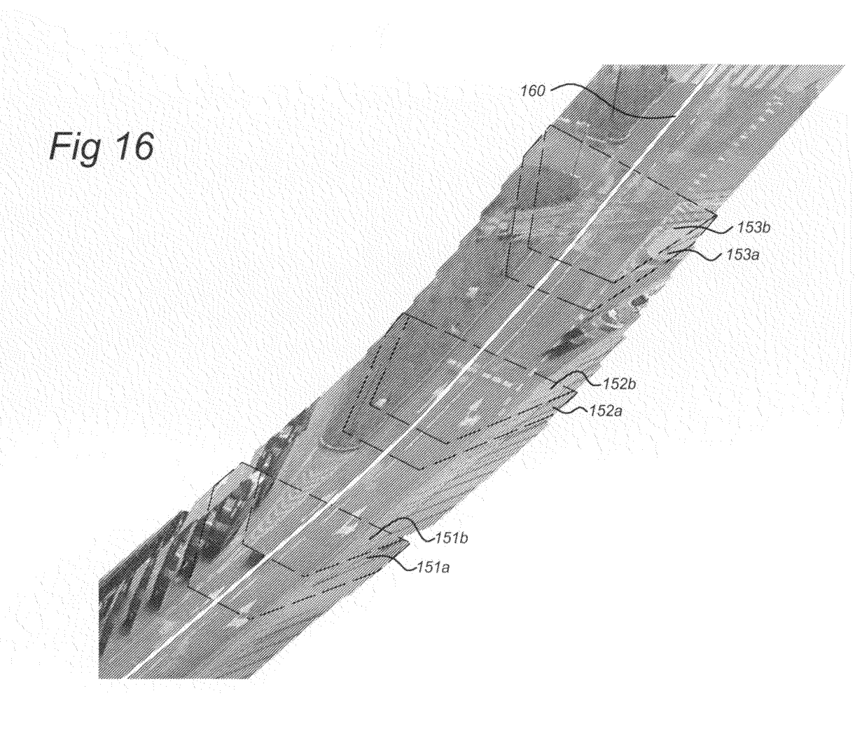

FIG. 16 shows an orthorectified mosaic of the road surface obtained from the images sequence corresponding to the three source images shown in FIGS. 15a-c as well as intervening images. In the orthorectified mosaic the area corresponding to the three images is indicated. The areas indicated by 151a, 152a and 153a correspond to the orthorectified part of the sources images shown in FIGS. 15a, 15b and 15c, respectively. The areas indicated by 151b, 152b and 153b correspond to areas that could have been obtained by orthorectification of the corresponding part of the source images shown in FIGS. 15a, 15b and 15c, respectively, but which are not used in the orthorectified mosaic as the images subsequent to source images shown in FIGS. 15a-15c provides the same area but with higher resolution and less chance that a car in front of the car is obstructing a view of the road surface as the distance between the position of the camera and the road surface is shorter. The furthest parts of 151b, 152b and 153b are also not used but instead subsequent images (not indicated in FIG. 16) are used, again for the same reason. It can be seen that only a small area of the source image is used in the orthorectified mosaic. The area used corresponds to the road surface from a predefined distance from the MMS system up to a distance which is related to the travel speed of the MMS system during a subsequent time interval corresponding to the frame rate. The area used of a source image will increase with increase of the travel speed. In FIG. 16 is further indicated the track line 160 of the MMS system. The maximum distance between the camera position and the road surface represented by a pixel of a source image is preferable smaller than the minimum distance between two vehicles driving on a road. If this is the case, an orthorectified mosaic of the road surface of a road section can be generated which does not show distortions due to vehicles driving in front of the MMS system.

Furthermore, from FIG. 16 can easily been seen that each part of the road surface is captured in at least two images. Part of the areas indicated by 151b, 152b and 153b can be seen to be also covered by orthorectified images obtained from the images shown in FIGS. 15a-c. It is not showed but can easily be inferred that part of the areas 151b, 152b and 153b are orthorectified parts from images which are subsequent to the images shown in FIGS. 15a-c. Whereas in the images of the image sequence shown in FIGS. 15a-c cars are visible, those cars are not visual anymore in the orthorectified mosaic. It should be noted that area 151a shows dark components of the undercarriage of the car directly in front. As the corresponding geographical area in the preceding image shows something else then said dark components, said pixels corresponding to the dark components will be marked as moving object pixels and will be excluded from the road color sample.

The method described above, is used to generate a road color sample representative of the road surface color. From the source images shown in FIG. 15 and the orthorectified mosaic shown in FIG. 16 can be seen that road surface does not have a uniform color. The orthorectified mosaic is used to determine the road information, such as road width, lane width. Above is disclosed how a road color sample is used to determine which pixels correspond to the road surface and which of the pixels don't. Furthermore, above is described how for each pixel can be determined whether it is a stationary pixel or a moving object pixel. These methods are also used to determine a road color sample suitable to determine in the orthorectified mosaic the pixels corresponding to the road surface. The road color sample could be determined from pixels associated with a predefined area in one source image representative of the road surface in front of the moving vehicle on which the camera is mounted. However, if the road surface in said predefined area does not comprise shadows, the road color sample will not assign pixels corresponding to a shadowed road surface to the road surface image that will be generated for the orthorectified mosaic. Therefore, in an embodiment of the invention, the road color sample is determined from more than one consecutive image. The road color sample could correspond to all pixel values present in a predefined area of the orthorectified images used to construe the orthorectified mosaic. In another embodiment the road color sample corresponds to all pixels values present in a predefined area of the orthorectified mosaic, wherein the predefined area comprises all pixels in a strip which follows the track line 160 of the moving vehicle. The track line could be in the middle of the strip but should be some where in the strip. The road color sample thus obtained will comprise almost all color values of the road surface enabling the application to detect almost correctly in the orthorectified mosaic all pixels corresponding to the road surface and to obtain the road surface image from which the road information such as position of the road edges can be determined.

In an embodiment, the road color sample has been determined from the stationary pixels in the predefined area and moving object pixels are excluded. The road color sample comprises in this embodiment only the color values of pixels in the predetermined area which are not classified as moving object pixels. In this way, the road color sample represents better the color of the road surface.

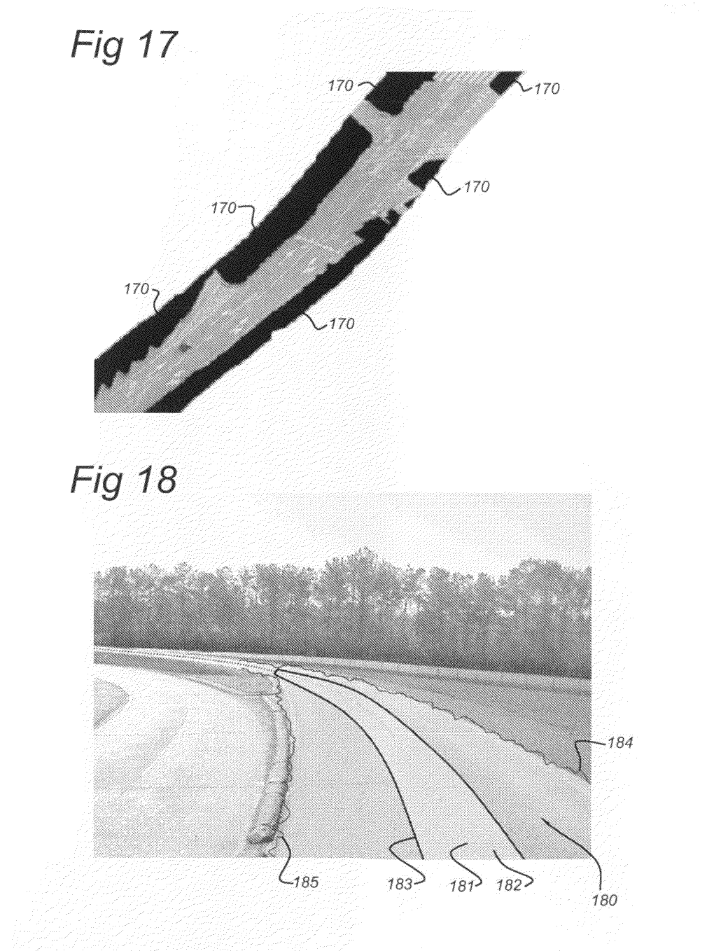

FIG. 17 shows the orthorectified mosaic of FIG. 16 with on top the road surface image. The areas 170 indicate the areas of pixels that are not classified as road surface pixels. The pixels classified as road surface pixels are transparent in FIG. 17.

The pixels forming the boundary between the areas 170 and the transparent area in FIG. 17 will be assigned as road edge pixels and used to determine road information such as position of the road edges and road centerline.

It should be noted, that the orthorectified mosaic is a composition of areas of the source images representing a predefined area in front of the moving vehicle. Consequently, the road surface image generated from the orthorectified mosaic is a composition of areas of the source images representing a predefined area in front of the moving vehicle.

The method described above will work properly when it is guaranteed that no moving object has present in the predefined area in front of the moving vehicle during capturing the image sequence. However, this will not always be the case. In FIG. 16, the mosaic part corresponding to source image 2 comprises a shadow. The color values corresponding to said shadow could result improper generation of the road surface image. Therefore, for each pixel used to generate the road color sample is determined whether it corresponds to a stationary pixel or a moving object pixel as described above.

For the orthorectified mosaic, a corresponding image, i.e. moving object image, will be generated identifying for each pixel whether the corresponding pixel in the orthorectified mosaic is a stationary pixel of a moving object pixel. Then only the pixel values of the pixels in the strip following the track line of the moving vehicle are used to obtain the road color sample and all pixels in the strip classified as moving object pixel will be excluded. In this way, only pixel values of pixels which are identified in two subsequent images of the image sequence as stationary pixel are used to obtain the road color sample. This will improve the quality of the road color sample and consequently the quality of the road surface image.

When applying the moving object detection described above, the pixels corresponding to the shadow will be identified as moving object pixels as in the previous image in the image sequence, the corresponding pixels in the orthorectified image will show the vehicle in front of the moving vehicle, which color significantly differs from the shadowed road surface.

The moving object image could further be used to improve the determination of the position of the road edges in the road surface image corresponding to the orthorectified mosaic. A method to improve is described before.

Road sections or along a trajectory are in most cases not straight. FIG. 16 shows a slightly bent road. Well known curve fitting algorithms could be used to determine the position of the road edge in the road surface image and subsequently the geo-position of the road edge. Road edge pixels that are classified as moving object pixels could be excluded from the curve fitting algorithm.

It is shown, that the method according to the invention can be applied on both orthorectified images and orthorectified mosaics. In both cases, the road color sample is determined from pixels associated with a predefined area in one or more source images representative of the road surface in front of the moving vehicle including the track line of the moving vehicle. Furthermore, the road surface image is generated from one or more source images in dependence of the road color sample and the road information is produced in dependence of the road surface image and position and orientation data associated with the source image.

For both type of images is preferably first determined for each pixel whether it is a stationary pixel or a moving object pixel. For this, a common area within two consecutive source images is used, wherein the common area represents in each of the images a similar geographical area of the road surface when projected on the same plane. Then, this information is used to exclude only pixels corresponding to moving objects from determining the road color sample and to improve the method for producing road information.

It should be noted that if only one source image is used to produce the road information, the source image can be used to determine the road color sample and to generate the binary road surface image. From said binary road surface image the road edge pixels can be retrieved. By means of the road edge pixels and associated position and orientation data, the best line parallel to the driving direction can be determined. The formula's to convert a source image into an orthorectified image can be used to determine the lines in an source image that are parallel to the driving direction.

FIG. 18 illustrates an embodiment of the method according to the invention when applied on one source image. FIG. 18 shows a bent road 180 and the track line of the vehicle 181. The track line of the vehicle could be determined in image by means of the position and orientation data associated with the image sequence. The track line 181 is used to determine the predefined area 182 in the image representative of the road surface in front of the moving vehicle. Line 183 indicates the outer line of the predefined area 182. The area 182 is a strip with a predefined width in real world having two sides being parallel to the track line of the vehicle 181. It could be seen that the area 182 extends up to a predefined distance in front of the vehicle. All values of the pixels in the predefined area 182 are used to obtain the road color sample. All color values are used to classify each pixel as road surface pixel or not a road surface pixel and to generate a corresponding road surface image. Line 184 illustrates the road edge pixels corresponding to the right side of the road surface 180 and line 185 illustrates the road edge pixels corresponding to the left side of the road surface 180. A curve fitting algorithm could be used to determine the curve of the road edges and the centerline curve, not shown. By means of the position and orientation data associated with the image, coordinates for the road edges and centerline can be calculated.

The method according to the invention will work on only one image when it can be guaranteed that no car is directly in front of the vehicle. If this can not be guaranteed, pixels corresponding to moving objects could be determined in a part of the predefined area 182 as described above by using the common area of said part in a subsequent image.

Be means of the method described above, the absolute position of the center line of a road can be determined. Furthermore, the absolute position of the roadsides and the road width indicative for the relative position of the roadside with respect to the center line can be determined. These determined road information is stored in a database for use in a map-database. The road information can be used to produce a more realistic view of the road surface in a navigation system. For example, narrowing of a road can be visualized. Furthermore, the width of a road in the database can be very useful for determining the best route for exceptional transport, that could be hindered by too narrow roads.

FIG. 14 illustrates a high level block diagram of a computer system which can be used to implement a road information generator performing the method described above.

The computer system of FIG. 14 includes a processor unit 1412 and main memory 1414. Processor unit 1412 may contain a single microprocessor, or may contain a plurality of microprocessors for configuring the computer system as a multi-processor system. Main memory 1414 stores, in part, instructions and data for execution by processor unit 1412. If the method of the present invention is wholly or partially implemented in software, main memory 1414 stores the executable code when in operation. Main memory 1414 may include banks of dynamic random access memory (DRAM) as well as high speed cache memory.

The system of FIG. 14 further includes a mass storage device 1416, peripheral device(s) 1418, input device(s) 1420, portable storage medium drive(s) 1422, a graphics subsystem 1424 and an output display 1426. For purposes of simplicity, the components shown in FIG. 14 are depicted as being connected via a single bus 1428. However, the components may be connected through one or more data transport means.

For example, processor unit 1412 and main memory 1414 may be connected via a local microprocessor bus, and the mass storage device 1416, peripheral device(s) 1418, portable storage medium drive(s) 1422, and graphics subsystem 1424 may be connected via one or more input/output (I/O) buses. Mass storage device 1416, which may be implemented with a magnetic disk drive or an optical disk drive, is a non-volatile storage device for storing data, such as the geo-coded image sequences of the respective cameras, calibration information of the cameras, constant and variable position parameters, constant and variable orientation parameters, the orthorectified tiles, road color samples, generated road information, and instructions for use by processor unit 1412. In one embodiment, mass storage device 1416 stores the system software or computer program for implementing the present invention for purposes of loading to main memory 1414.

Portable storage medium drive 1422 operates in conjunction with a portable non-volatile storage medium, such as a floppy disk, micro drive and flash memory, to input and output data and code to and from the computer system of FIG. 14. In one embodiment, the system software for implementing the present invention is stored on a processor readable medium in the form of such a portable medium, and is input to the computer system via the portable storage medium drive 1422. Peripheral device(s) 1418 may include any type of computer support device, such as an input/output (I/O) interface, to add additional functionality to the computer system. For example, peripheral device(s) 1418 may include a network interface card for interfacing computer system to a network, a modem, etc.

Input device(s) 1420 provide a portion of a user interface. Input device(s) 1420 may include an alpha-numeric keypad for inputting alpha-numeric and other key information, or a pointing device, such as a mouse, a trackball, stylus, or cursor direction keys. In order to display textual and graphical information, the computer system of FIG. 14 includes graphics subsystem 1424 and output display 1426.

Output display 1426 may include a cathode ray tube (CRT) display, liquid crystal display (LCD) or other suitable display device. Graphics subsystem 1424 receives textual and graphical information, and processes the information for output to display 1426. Output display 1426 can be used to report the results of the method according to the invention by overlaying the calculated center line and road edges over the associated orthorectified image, display an orthorectified mosaic, display directions, display confirming information and/or display other information that is part of a user interface. The system of FIG. 14 also includes an audio system 1428, which includes a microphone. In one embodiment, audio system 1428 includes a sound card that receives audio signals from the microphone. Additionally, the system of FIG. 14 includes output devices 1432. Examples of suitable output devices include speakers, printers, etc.

The components contained in the computer system of FIG. 14 are those typically found in general purpose computer systems, and are intended to represent a broad category of such computer components that are well known in the art.

Thus, the computer system of FIG. 14 can be a personal computer, workstation, minicomputer, mainframe computer, etc. The computer can also include different bus configurations, networked platforms, multi-processor platforms, etc. Various operating systems can be used including UNIX, Solaris, Linux, Windows, Macintosh OS, and other suitable operating systems.

The method described above could be performed automatically. It might happen that the quality of the images is such that the image processing tools and object recognition tools performing the invention need some correction. For example the superposing of the calculated roadsides on the associated orthorectified tile shows an undesired visible departure. In that case the method includes some verification and manual adaptation actions to enable the possibility to confirm or adapt intermediate results. These actions could also be suitable for accepting intermediate results or the final result of the road information generation. Furthermore, the number of questionable marks in one or more subsequent images could be used to request a human to perform a verification.

The road information produced by the invention produces road information for each image and stores it in a database. The road information could be further processed to reduce the amount of information. For example, the road information corresponding to images associated with a road section could be reduced to one parameter for the road width for said section. Furthermore, if the road section is smooth enough, a centerline could be described by a set of parameters including at least the end points and shape points for said section. The line representing the centerline could be stored by the coefficients of a polynomial.

The foregoing detailed description of the invention has been presented for purposes of illustration and description. It is not intended to be exhaustive or to limit the invention to the precise form disclosed, and obviously many modifications and variations are possible in light of the above teaching. For example, instead of a camera recording the road surface in front of the moving vehicle a camera recording the road surface behind the moving vehicle could be used. Furthermore, the invention is also suitable to determine the position of lane dividers or other linear road markings in the orthorectified images.

The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. Method of producing road information for a map database comprising:
acquiring one or more source images from an image sequence obtained by use of a terrestrial based camera mounted on a moving vehicle;
determining a road color sample from pixels associated with an area in the acquired one or more source images representative of a road surface in front of or behind the moving vehicle, including the track line of the moving vehicle;
generating a road surface image from the acquired one or more source images in dependence of the determined road color sample; and,
producing road information in dependence of the generated road surface image and position and orientation data associated with the acquired one or more source images.

2. Method according to claim 1, wherein the producing of the road information comprises:
determining road edge pixels in the road surface image;
performing curve fitting on the determined road edge pixels to obtain a curve representing a road edge, and
producing the road information in dependence of the position of the obtained curve in the road surface image and the corresponding position and orientation data.

3. Method according to claim 1, wherein the road surface image is selected from an area of the acquired one or more source images representing an area in front of the moving vehicle, including the track line of the moving vehicle.

4. Method according to claim 1, wherein the acquiring of the one or more source images comprises:
processing one or more images from the image sequence in dependence of position data and orientation data associated with said one or more images to obtain the one or more source images, wherein each of the one or more source images corresponds to an orthorectified image.

5. Method according to claim 1, wherein the road color sample is taken from more than one consecutive images.

6. Method according to claim 1, further comprising:
determining a common area within two consecutive source images, of the one or more source images, representing a similar geographical area of the road surface; and
determining, for pixels of the determined common area whether to the pixels are to be classified as a stationary pixel or a moving object pixel.

7. Method according to claim 6, wherein the road color sample is determined from pixels classified as stationary pixels in the area wherein pixels classified as moving object pixels are excluded.

8. Method according to claim 1, wherein the road surface image is an orthorectified mosaic obtained from subsequent source images.

9. Method according to claim 1, wherein the road surface image is an orthorectified mosaic obtained from orthorectified images, each representing an area in front of or behind the vehicle.

10. Method according to claim 6, wherein the generating of the road surface image comprises:
marking pixels as stationary pixels or moving object pixels in the road surface image.

11. Method according to claim 10, wherein the producing of the road information comprises:
assigning a pixel of the road surface image as a road edge pixel in dependence of the marking as non stationary pixel.

12. An apparatus, comprising:
an input device;
a processor readable storage medium; and
a processor to communicate with said input device and said processor readable storage medium;
an output device to enable the connection with a display unit, said processor readable storage medium storing code to program said processor to perform at least:
acquiring a source image from an image sequence obtained by use of a terrestrial based camera mounted on a moving vehicle;
determining a road color sample from pixels associated with an area in the acquired source image representative of a road surface in front of or behind the moving vehicle;
generating a road surface image from the acquired source image in dependence of the determined road color sample; and
producing road information in dependence of the generated road surface image and position and orientation data associated with the source image.

13. (canceled)

14. (canceled)

15. Method according to claim 2, wherein the road surface image is selected from an area of the acquired one or more source images representing an area in front of the moving vehicle, including the track line of the moving vehicle.

16. Method according to claim 2, wherein the acquiring of the one or more source images comprises:
processing one or more images from the image sequence in dependence of position data and orientation data associated with said one or more images to obtain the one or more source images, wherein each of the one or more source images corresponds to an orthorectified image.

17. Method according to claim 6, wherein the road surface image is an orthorectified mosaic obtained from orthorectified images, each representing an area in front of or behind the vehicle.

18. Method according to claim 17, wherein the generating of the road surface image comprises:
marking pixels as stationary pixels or moving object pixels in the road surface image.

19. Method according to claim 18, wherein the producing of the road information comprises:
assigning a pixel of the road surface image as a road edge pixel in dependence of the marking as non stationary pixel.

20. A computer readable medium including program segments for, when executed on a computer device, causing the computer device to implement the method of claim 1.

21. Method of producing road information for use in a map database comprising:
acquiring a source image from an image sequence obtained by a terrestrial based camera mounted on a moving vehicle;
determining a road color sample from pixels associated with an area in the acquired source image representative of a road surface in front of or behind the moving vehicle;
generating a road surface image from the acquired source image in dependence of the determined road color sample; and
producing road information in dependence of the generated road surface image and position and orientation data associated with the source image.

22. A computer readable medium including program segments for, when executed on a computer device, causing the computer device to implement the method of claim 21.
